(19) United States
(12) Patent Application Publication
(10) Pub. No.: US 2018/0106071 A1
(43) Pub. Date: Apr. 19, 2018

(54) DOUBLE DOOR SAFETY LOCK

(71) Applicant: Raymond IVY, FOUNTAIN, CO (US)

(72) Inventor: Raymond IVY, FOUNTAIN, CO (US)

(21) Appl. No.: 15/298,079

(22) Filed: Oct. 19, 2016

(51) Int. Cl. E05B 13/00; E05B 65/44; E05C 19/00; E05C 7/00

(52) U.S. Cl. CPC E05B 13/002; E05C 7/00; E05C 19/003; E05B 65/44

(57) ABSTRACT

The present invention provides a locking device based on a rack and pinion mechanism for securing a double door system, for example cabinets with double door. The locking system comprises a pair of jaws extending from a central housing and adapted to mount over the two handles of double door and the jaws are operably coupled to a gear assembly enclosed in the central housing. The gear assembly could be cranked to move the jaws laterally in extended and retracted position for tightening and loosening the locking device over the handles.

### BACKGROUND OF THE INVENTION

### (1) Field of Iinvention

The present invention relates to a safety device and in particular to a locking system used for securing the double doors.

### (2) Background of Invention

The cabinets are generally provided with double doors and also large entry points in a household or like places also generally have double doors. From safety point of view, single doors are more secured in comparison to double doors, however for covering large entry points, the double doors are more suitable than single doors which otherwise have to be made in very large sizes. The double doors are usually provided with handles or knobs for opening the individual doors. The double doors may or may not be secured using locks, for example the cabinets having normal household items may not require locks. However, a need could be arise for securing the cabinets with double doors that does not have any locks. Thus, the present invention aims to solve the problem of securing cabinets having double doors.

Prior art designs are many, and a few are as follows, which are herein incorporated by reference for their supportive teachings illustrating what one skilled in the art is aware of:

U.S. Pat. No. 4,679,415, by Spatt, teaches of a rack and pinion locking mechanism.

U.S. Pat. No. 3,792,885, by Giardina et al., teaches of a double bar lock using a rack and pinion locking mechanism.

### BRIEF SUMMARY OF THE INVENTION

The present invention, therefore, has as its principal object to provide a locking device for securing double doors.

Another object of present invention is that the locking device is easy to use.

A further object of the present invention is that the locking device can be adapted to different double door sizes and designs.

Still another object of the present invention is that the locking device does not harm any component of the doors.

Yet another object of present invention is that the locking device is economical to manufacture.

Certain embodiments of present invention, but are not limited to, is to provide a locking device for a double door system wherein the double door system is a pair of door panels mounted in the opening of a frame and the panels are hinged at opposite edges to the frame while the adjacent free edges of the panels could swing freely and further having a pair of handles mounted on each panel near the adjacent free edges. The locking device is adapted to mount on the handle restricting the free swing movement of the panels, the locking device comprising a pair of jaws extending in opposite direction from a central housing. The jaws having a curved head portion adapted to be hooked to the handle and the tail portion operably coupled to the central housing. The tail portion is adapted for having teeth referred herein as rack, which could engage with the teeth of a pinion (gear) provided in the central housing for driving the jaws in linear motion i.e. extended and retracted positions. The gear assembly is configured to be driven by a key for translation of the jaws in extended and retracted position.

In one embodiment the central housing is provided with a hole permitting entry of a key that could engage with the gear assembly for driving the Jaws.

In another embodiment a lever operably coupled to the gear assembly for driving the jaws is provided on the central housing.

In another embodiment, the gear assembly is configured to permit free one side movement of the jaws i.e. the jaws could be retracted by pushing inwards.

In another embodiment, the Jaws could swivel freely allowing wherein the curved head portion is swivably coupled to the rack tail portion.

Reference throughout this specification to features, advantages, or similar language does not imply that all of the features advantages that may be realized with the present invention should be or are in any single embodiment or the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

### BRIEF DESCRIPTION OF THE DRAWINGS

In order for the advantages of the invention to be readily understood, a more particular description of the invention briefly described above will be rendered by reference to specific embodiments that are illustrated in the appended drawings. It is to be understood that these drawings depict only typical embodiments of the invention and are not therefore to be considered to be limiting of its scope, the invention will be described and explained with additional specificity and detail through the use of the accompanying drawings.

FIG. 1 is the schematic view of front side of one embodiment of a double door lock.

FIG. 2 is an illustrated embodiment of the device of FIG. 1 mounted to double doors.

### DETAILED DESCRIPTION OF THE ILLUSTRATED EMBODIMENTS

The present invention provides a locking device for securing double door systems, for example securing the cabinets having double doors with handles from each door being close to each other and opening in opposite directions; one on the right opening right and the one on the left opening one left (not shown).

Before explaining at least one embodiment of the invention in detail, it is to be understood that the invention is not limited in its application to the details of construction and the arrangements of the components set forth in the following description. The invention is capable of other embodiments and of being practiced and carried out in various ways. Also it is to be understood that the phraseology and terminology employed herein are for the purpose of description and should not be regarded as limiting.

As used in this specification and the appended claims, the singular forms “a”, “an”, and “the” include plural referents unless the content clearly dictates otherwise.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The present invention provides a locking device for use in securing a double door system. The double doors system is usually provided in cabinets and entries having a large opening, for example French doors. Double door systems typically include a pair of door panels mounted in a frame wherein each of the panels are hinged to the frame at one of the long edge, and the opposite edge is free to swing outwards. The free edges of the two panels are adjacent to each other and suitable handles are provided near the free edges that allow a person to grab the handle and pull for opening the doors in opposite directions - left and right respectively.

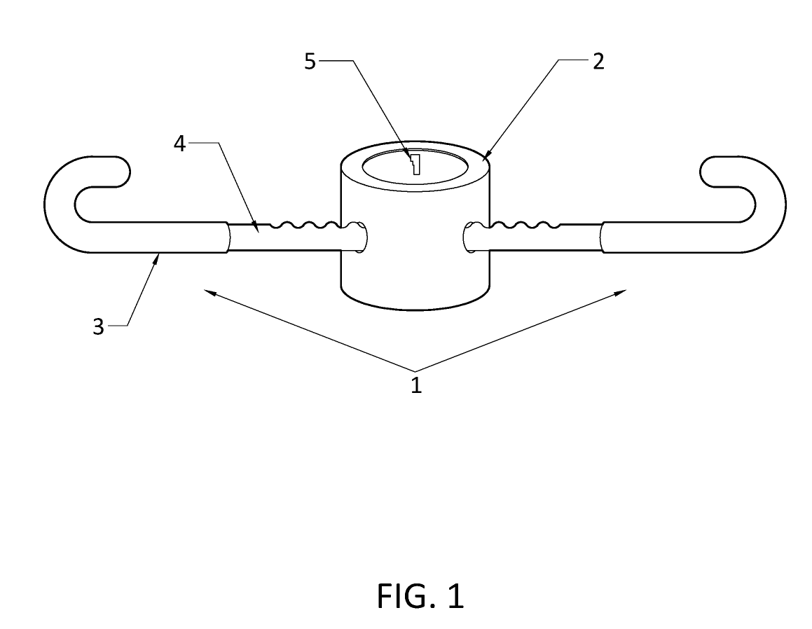

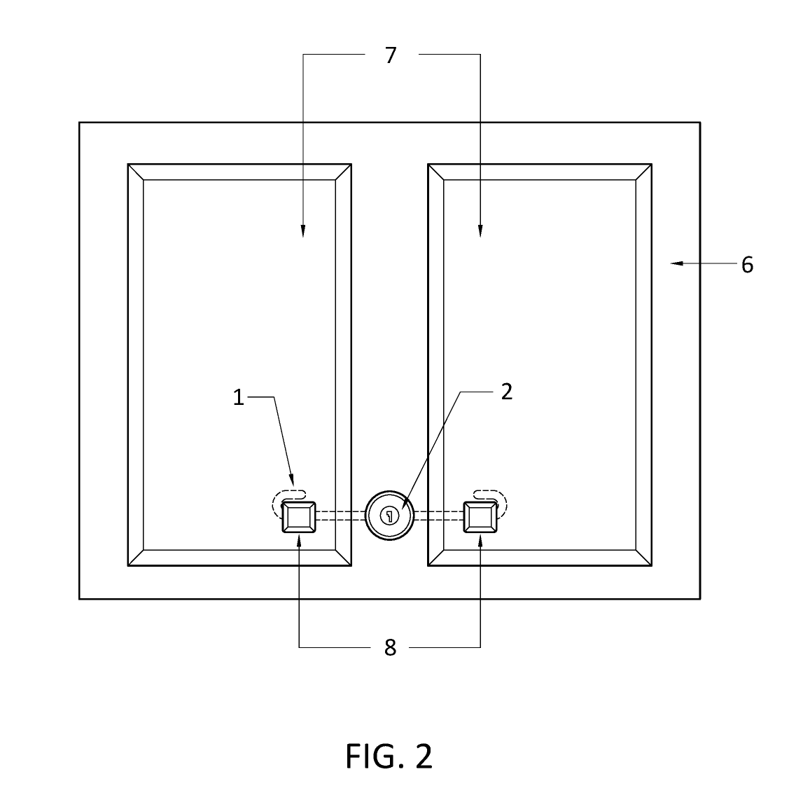

Now looking at FIGS. 1 and 2 showing an exemplary embodiment of the present invention, which is a double door locking system. Illustrated is the locking device having a pair of jaws 1 protruding from the central housing 2. The jaws 1 include a curved head portion 3 that hooks to the handle 8 of the door 7 that is mounted to a frame 6 of cabinets, or other items, and a tail portion 4. The curved portion 3 lies over, or is placed over, the handle 8 of the door 7. For example, one skilled in the art will easily understand that the handle 8 could be a knob and the curved head portion 3 is hooked to the rear side (stem) of the knob as shown in FIG. 2. The tail portion 4 of the jaw is elongated and have longitudinal array of teeth similar to the rack teeth. Enclosed in the central housing 2 are the jaws 1 that are operably engaged to a gear assembly typically used in a rack and pinion art, as taught in the prior art cited and incorporated by reference in the Background section of this application. The gear assembly is engaged to the jaws 1 through pinion type of teeth that could move the jaws laterally in extended and retracted position. The two jaws 1 are coupled in opposite direction of the gear assembly and also moves outwards in opposite directions.

The central housing 2 includes a hole 5 through which a key could be inserted for driving the gear assembly for moving the jaws 1, for example the key could be turned clockwise to crank the gear assembly for moving the jaws 1 outwards to extended position and similarly the key could be turned in anti-clockwise direction to move the jaws 1 inwards. Alternatively a lever could be provided protruding from the central housing 2 and operably coupled to gear assembly. The lever (not shown) could be turned manually by a person to crank the gear assembly for moving the jaws 1 in a desired direction.

In another embodiment, the curved head portion 3 of the jaw 1 may be continuous to the tail portion 4 and made of same material as the tail portion. Alternatively, the curved head portion 3 may be swivably coupled to the tail portion 4 allowing the head portion 3 to freely rotate along the longitudinal axis. The free rotation of the curved head portion 3 allows the jaw 1 to be easily clamped to different double door systems have distinct handle shapes and position. Furthermore the curved head portion 3 could be provided with an outer layer of soft material that provide grip and cushioning, preventing any damage to the handle by the jaws 1.

To use the locking device of present invention, a user simply extends the jaws 1 outward by cranking the gear assembly to sufficient length that the locking assembly could overlie the handles and then clutched on the handles. Then the gear assembly could be cranked in opposite direction to retract the jaws 1 inwards fitting over the handle. To remove the locking device, the gear assembly is cranked to move the jaws 1 outwards loosening the locking device that could then be taken off.

Although the various illustrations and accompanied language have depicted certain embodiments in various fashion, one skilled in the mechanical arts will understand that there are many methods and designs that may accomplish the desires of the intended invention. For example, though curved head portions are illustrated, most any type or shape of a grappling or attachment design may be employed. Further, although the central housing 2 is illustrated in a circular tube shape, most any known shape capable of housing the components will be suitable.

The present disclosure should not be construed in any limited sense other than that limited by the scope of the claims having regard to the teachings herein and the prior art being apparent with the preferred form of the invention disclosed herein and which reveals details of structure of a preferred form necessary for a better understanding of the invention and may be subject to change by skilled persons within the scope of the invention without departing from the concept thereof.

What is claimed is:

1. A locking device for securing a pair of door panels mounted in an opening of a frame wherein the door panels are hinged at opposite edges to the frame while adjacent free edges of the panels could swing freely, each door panel having a handle mounted near the adjacent free edges, wherein the locking device comprising:
a. a pair of jaws, having a curved head portion and a tail portion, the curved portion adapted to hook to the pair of handles, the tail portion is adapted to have longitudinal rack teeth mounted therealong a top surface thereof;
b. a gear assembly operably coupled to the pair of jaw in opposite direction wherein pinion teeth present in said gear assembly engage with the rack teeth for moving the pair of jaws in opposite directions;
c. a driving means to crank said gear assembly for moving the pair of jaw in an extended position and a retracted position.

2. The locking device of claim 1, wherein the locking device further comprise a central housing enclosing the gear assembly and the pair of jaws protruding from the central housing in opposite directions.

3. The locking device of claim 1, wherein the pair of door panels is mounted in a frame of a cabinet.

4. The locking device of claim 1, wherein said handle is a knob.

5. The locking device of claim 1, wherein said curved head portion of the jaw is swivably coupled the the tail portion.

6. The locking device of claim 1, wherein the driving means is key configured to removably engage with the gear assembly for driving the pair of jaws.
